(19) United States
(12) Patent Application Publication
(10) Pub. No.: US 2019/0032740 A1
(43) Pub. Date: Jan. 31, 2019

(54) VIBRATION DAMPING DEVICE

(71) Applicant: SUMITOMO RIKO COMPANY LIMITED, Komaki-shi (JP)

(72) Inventors: Hiroyuki KASHIHARA, Komaki-shi (JP); Hirotaka MATSUI, Novi, MI (US); Mutsumi MURAOKA, Novi, MI (US)

(73) Assignee: SUMITOMO RIKO COMPANY LIMITED, Komaki-shi (JP)

(21) Appl. No.: 15/659,823

(22) Filed: Jul. 26, 2017

(51) Int. Cl. F16F 1/371

(52) U.S. Cl. CPC F16F 1/371; F16F 1/44

(57) ABSTRACT

A vibration damping device including first and second side opposition surfaces mutually and separately opposed and elastically connected by a main rubber elastic body. A protruding part is provided at the first side opposition surface to protrude toward the second side opposition surface with a protrusion dimension with which the protruding part does not reach the second side opposition surface, in a section peripherally inside an outer peripheral edge of the main rubber elastic body. A recessed part is provided at the second side opposition surface in opposition to the protruding part so as to be recessed to a distant side from the protruding part and open in the second side opposition surface. The protruding part has an outer face without a break and is buried in the main rubber elastic body. The recessed part is filled with the main rubber elastic body.

### TECHNICAL FIELD

This invention relates to a vibration damping device disposed between components that should be linked in a vibration-damping manner.

### BACKGROUND ART

Conventionally, there has been known a vibration damping device having a structure wherein a first mounting member and a second mounting member that are disposed to be mutually opposed are connected by a main rubber elastic body, as a kind of vibration damping apparatus disposed between components that should be linked in a vibration-damping manner. In this vibration damping device, as Japanese Unexamined Patent Publication No. JP-A-2005-240926 (Patent Document 1) discloses for example, flat-plate-shaped opposition surfaces provided at both the first and second mounting members are disposed to be mutually opposed and elastically connected to each other by the main rubber elastic body interposed between them.

In the vibration damping device of this structure, the required spring characteristics can be obtained by adjusting the distance in between and the angle with respect to the pair of opposition surfaces between which the main rubber elastic body is disposed. Meanwhile, the durability of the main rubber elastic body can be improved by greatly keeping the free length of the main rubber elastic body.

However, the free length of the main rubber elastic body is determined by the distance between the pair of opposition surfaces. Therefore, when the distance between the opposition surfaces is limited because of the required spring characteristics, it may be impossible to keep an enough free length to ensure the durability of the main rubber elastic body.

### BACKGROUND ART DOCUMENT(S)

### Patent Document(s)

Patent Document 1: JP-A-2005-240926

### SUMMARY OF THE INVENTION

### Problems the Invention Attempts to Solve

The present invention was established in view of the above background, and one object of the present invention to provide a vibration damping device of novel structure which is able to realize both obtainment of the required spring characteristics and improvement of the durability of the main rubber elastic body.

### Means for Solving the Problem

The modes of this invention that were established in order to solve that problem are described hereinafter. Furthermore, the elements used in each mode indicated below are, as much as possible, adoptable in desired combinations.

A first mode of the present invention provides a vibration damping device for linking components in a vibration-damping manner comprising: a first mounting member configured to be mounted on one of the components; a second mounting member configured to be mounted on an other of the components; at least one first side opposition surface provided in the first mounting member; at least one second side opposition surface provided in the second mounting member and opposed to the first side opposition surface with a gap in between; at least one main rubber elastic body being disposed between the first side opposition surface and the second side opposition surface to elastically connect them; a protruding part provided at the first side opposition surface so as to protrude toward the second side opposition surface with a protrusion dimension with which the protruding part does not reach the second side opposition surface, in a section located peripherally inside an outer peripheral edge of the main rubber elastic body, the protruding part having an outer face without a break and being buried in the main rubber elastic body; and a recessed part provided at the second side opposition surface in opposition to the protruding part while being recessed to a distant side from the protruding part and opening in the second side opposition surface, the recessed part being filled with the main rubber elastic body.

According to the present mode, in the area between the opposed faces of the first side opposition surface and the second side opposition surface elastically connected by the main rubber elastic body, the protruding part is provided at the first side opposition surface. The protruding part protrudes toward the second side opposition surface with the protrusion dimension with which the protruding part does not reach the second side opposition surface and it is buried in the main rubber elastic body, in the section located peripherally inside the outer peripheral edge of the main rubber elastic body. On the other hand, at the second side opposition surface, the recessed part is provided opening in the second side opposition surface, in opposition to the protruding part. The recessed part is recessed to the distant side from the protruding part and filled with the main rubber elastic body. This makes it possible to freely set the spring characteristics of the vibration damping device, by adjusting the separation distance between the protruding part and the second side opposition surface in the opposition direction for the first side opposition surface and the second side opposition surface. Meanwhile, for the outer peripheral edge of the main rubber elastic body, the distance between the opposed faces of the first side opposition surface and the second side opposition surface is made larger, since the protruding part is disposed between the first side opposition surface and the second side opposition surface. Therefore, the free length of the surface of the main rubber elastic body can be largely ensured, thereby enabling secure improvement in the durability of the main rubber elastic body, and hence that of the vibration damping device.

Besides, the protruding part buried in the main rubber elastic body has an outer face without a break, whereby the bonded area of the main rubber elastic body on the protruding part can increase, and thus the durability of the main rubber elastic body can further improve. Moreover, the recessed part, which is recessed to the distant side from the protruding part, is provided in opposition to the protruding part. Therefore, it is possible to sufficiently keep the separation distance between the tip part of the protruding part and the bottom face of the recessed part, thereby making it possible to improve the durability of the main rubber elastic body all the more for the increase in the rubber volume. In this way, according to the vibration damping device structured following the present mode, it is possible to advantageously realize securement of the required spring characteristics and improvement of the durability.

A second mode of this invention provides the vibration damping device according to the first mode, wherein, in an opposition direction for the first side opposition surface and the second side opposition surface, a minimum value of a thickness dimension of the main rubber elastic body is equal to or larger than 70% of a maximum value of the thickness dimension of the main rubber elastic body.

The present mode employs the protruding part and the recessed part recessed to the distant side from the protruding part that are disposed in opposition to each other such that the minimum value of the thickness dimension of the main rubber elastic body is equal to or larger than 70% of the maximum value of that, in the opposition direction for the first side opposition surface and the second side opposition surface. Formation of the protruding part may cause the thickness of the main rubber elastic body to locally thin between the first and second side opposition surfaces, and thus lead to deterioration of the durability. This configuration can favorably avoid this risk, whereby the durability can improve stably.

A third mode of this invention provides the vibration damping device according to the second mode, wherein the thickness dimension in the opposition direction between the first side opposition surface and the second side opposition surface at a peripheral edge of the main rubber elastic body is made substantially equal to the thickness dimension in the opposition direction between a protruding tip face of the protruding part and a bottom face of the recessed part at a central part of the main rubber elastic body.

According to the present mode, the thickness dimension in the opposition direction at the peripheral edge of the main rubber elastic body is made substantially equal to the thickness dimension in the opposition direction at the central part of the main rubber elastic body. This configuration can more advantageously avoid the durability deterioration by the main rubber elastic body thinning locally between the first and second side opposition surfaces due to the protruding part, whereby the durability can improve more stably.

A fourth mode of this invention provides the vibration damping device according to any one of the first to third modes, wherein each of the outer face of the protruding part buried in the main rubber elastic body and an inner face of the recessed part filled with the main rubber elastic body is constituted by a curved face without an edge.

According to the present mode, each of the outer face of the protruding part and the inner face of the recessed part is constituted by a curved face without an edge, whereby local stress concentration in relation to the main rubber elastic body is prevented, and the durability can be further improved.

A fifth mode of the present invention provides the vibration damping device according to any one of the first to fourth modes, wherein, as viewed in an opposition direction for the first side opposition surface and the second side opposition surface, a peripheral rim of a proximal end part of the protruding part is positioned peripherally inside an opening peripheral edge of the recessed part, and a width dimension of the proximal end part of the protruding part in a cross section orthogonal to the opposition direction is set equal to or larger than 50% of a width dimension of the opening peripheral edge of the recessed part.

With respect to the present mode, when viewed in the opposition direction for the first side opposition surface and the second side opposition surface, the peripheral rim of the proximal end part of the protruding part is positioned peripherally inside the opening peripheral edge of the recessed part. This avoids any part of the main rubber elastic body from being clamped directly between the proximal end part of the protruding part and the second side opposition surface in the opposition direction. Thus, the durability deterioration due to the protruding part is favorably prevented. Furthermore, the width dimension of the proximal end part of the protruding part is set equal to or larger than 50% of the width dimension of the opening peripheral edge of the recessed part. This makes it possible to ensure the spring characteristics of the vibration damping device set by the separation distance between the protruding part and the second side opposition surface in the opposition direction for the first side opposition surface and the second side opposition surface.

A sixth mode of this invention provides the vibration damping device according to any one of the first to fifth modes, wherein each of the first mounting member and the second mounting member has an elongated plate shape, and the first mounting member is disposed above the second mounting member so as to be opposed to the second mounting member with the gap in between, a pair of first inclination plate parts are provided at both end portions in a longitudinal direction of the first mounting member so as to be each inclined relative to a middle portion in the longitudinal direction of the first mounting member with respect to a plate thickness direction of the middle portion, a pair of second inclination plate parts are provided at both end portions in the longitudinal direction of the second mounting member so as to be each inclined to the same side of the plate thickness direction as the first inclination plate parts are inclined, the at least one first side opposition surface comprises a pair of first side opposition surfaces while the at least one second side opposition surface comprises a pair of second side opposition surfaces, and opposed faces of the pair of first inclination plate parts and the pair of second inclination plate parts are the pair of first side opposition surfaces and the pair of second side opposition surfaces, and the at least one main rubber elastic body comprises a pair of main rubber elastic bodies, and the pair of main rubber elastic bodies elastically connect the pair of first side opposition surfaces and the pair of second side opposition surfaces to each other, and a central portion of each of the second inclination plate parts is pushed out to a distant side from a corresponding one of the first inclination plate parts in opposition thereto so as to form the recessed part in each of the second side opposition surfaces.

According to the present mode, the main rubber elastic bodies are disposed between the opposed faces of the pair of first inclination plate parts and the pair of second inclination plate parts provided at the both end portions in the longitudinal direction of the first mounting member and the second mounting member, which have an elongated plate shape (between the first side opposition surfaces and the second side opposition surfaces). Therefore, by adjusting the inclination angle for the first inclination plate parts and the second inclination plate parts, it is possible to adjust the ratio between the spring in the longitudinal direction and the spring in the opposition direction for the first mounting member and the second mounting member. Here, the protruding parts and the recessed parts are provided respectively at the first inclination plate parts and the second inclination plate parts, whereby the central portion of each second inclination plate part is largely pushed out to the outside. However, each second inclination plate part is inclined relative to the middle portion in the longitudinal direction of the second mounting member, so that it is possible to smartly accommodate the recessed parts protruding outward in the void spaces made by the inclination. Thus, it is possible to improve the durability without enlargement of the disposition space.

### Effect of the Invention

According to the present invention, in the area between the opposed faces of the first side opposition surface and the second side opposition surface elastically connected by the main rubber elastic body, the protruding part is provided in the first side opposition surface, while protruding with the protrusion dimension with which the protruding part does not reach the second side opposition surface and being buried in the main rubber elastic body. On the other hand, the recessed part is provided in the second side opposition surface while opening in the second side opposition surface and being filled with the main rubber elastic body. Consequently, the spring characteristics of the vibration damping device may be freely set by adjusting the separation distance between the protruding part and the second side opposition surface. Meanwhile, in the outer peripheral edge of the main rubber elastic body, the distance between the opposed faces of the first side opposition surface and the second side opposition surface is made large, because of the disposition of the protruding part. This makes it possible to largely ensure the free length of the surface of the main rubber elastic body, and thus securely improve the durability of the main rubber elastic body and hence that of the vibration damping device. In addition, it is possible to increase the bonded area of the main rubber elastic body on the protruding part, whereby it is possible to further improve the durability of the main rubber elastic body. Moreover, since the recessed part is provided, it is also possible to sufficiently keep the separation distance between the tip part of the protruding part and the bottom face of the recessed part, and thus further improve the durability of the main rubber elastic body by the increase of the rubber volume. Therefore, it is possible to advantageously realize both securement of the required spring characteristics and improvement of the durability.

### BRIEF DESCRIPTION OF THE DRAWINGS

FIG. 1 is a perspective view of a vibration damping device as a first embodiment of this invention.

FIG. 2 is a plan view of the vibration damping device shown in FIG. 1.

FIG. 3 is a cross-sectional view taken along line 3-3 of FIG. 2.

FIG. 4 is a cross-sectional view taken along line 4-4 of FIG. 2.

FIG. 5 is a front view of the vibration damping device shown in FIG. 1, showing a state of being mounted on a vehicle.

FIG. 6 is a cross-sectional view taken along line 6-6 of FIG. 5.

FIG. 7 is a cross-sectional view taken along line 7-7 of FIG. 5.

FIG. 8 is a perspective view of a first mounting member shown in FIG. 1.

FIG. 9 is a plan view of FIG. 8.

FIG. 10 is a perspective view of a second mounting member shown in FIG. 1.

FIG. 11 is a plan view of FIG. 10.

FIG. 12 is a perspective view showing a vibration damping device as a second embodiment of the present invention.

FIG. 13 is a perspective view of the vibration damping device shown in FIG. 12, with a main rubber elastic body and a rubber stopper part removed.

FIG. 14 is a cross-sectional view of the vibration damping device shown in FIG. 12, corresponding to FIG. 3.

FIG. 15 is a cross-sectional view of the vibration damping device shown in FIG. 12, corresponding to FIG. 4.

FIG. 16 is a perspective view showing a vibration damping device as a third embodiment of the present invention.

FIG. 17 is a perspective view showing the vibration damping device shown in FIG. 16 from a different angle.

FIG. 18 is a perspective view of the vibration damping device shown in FIG. 17, with a main rubber elastic body and a rubber stopper part removed.

FIG. 19 is a plan view of the vibration damping device shown in FIG. 16.

FIG. 20 is a bottom view of the vibration damping device shown in FIG. 16.

FIG. 21 is a cross-sectional view of the vibration damping device shown in FIG. 16, corresponding to FIG. 3.

FIG. 22 is a cross-sectional view of the vibration damping device shown in FIG. 16, corresponding to FIG. 4.

FIG. 23 is a cross-sectional view showing a vibration damping device as a fourth embodiment of the present invention, corresponding to FIG. 3.

FIG. 24 is a cross-sectional view of the vibration damping device shown in FIG. 23, corresponding to FIG. 6.

### EMBODIMENTS FOR CARRYING OUT THE INVENTION

Embodiments of the present invention will be described hereinafter in reference to the drawings.

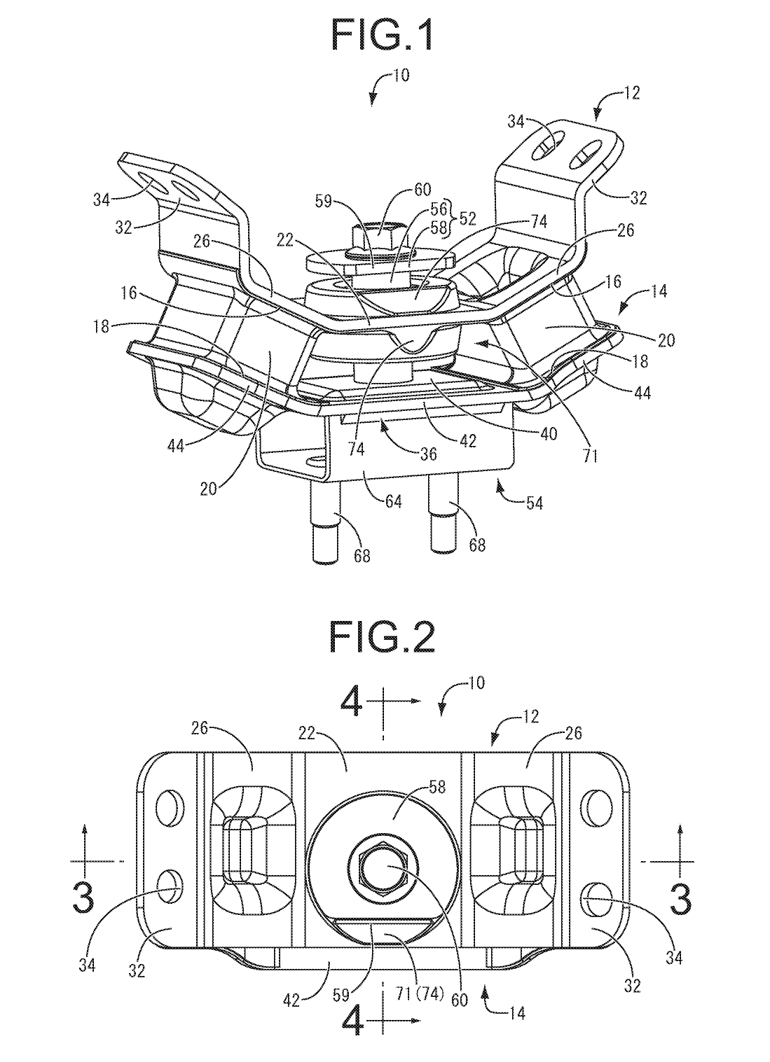

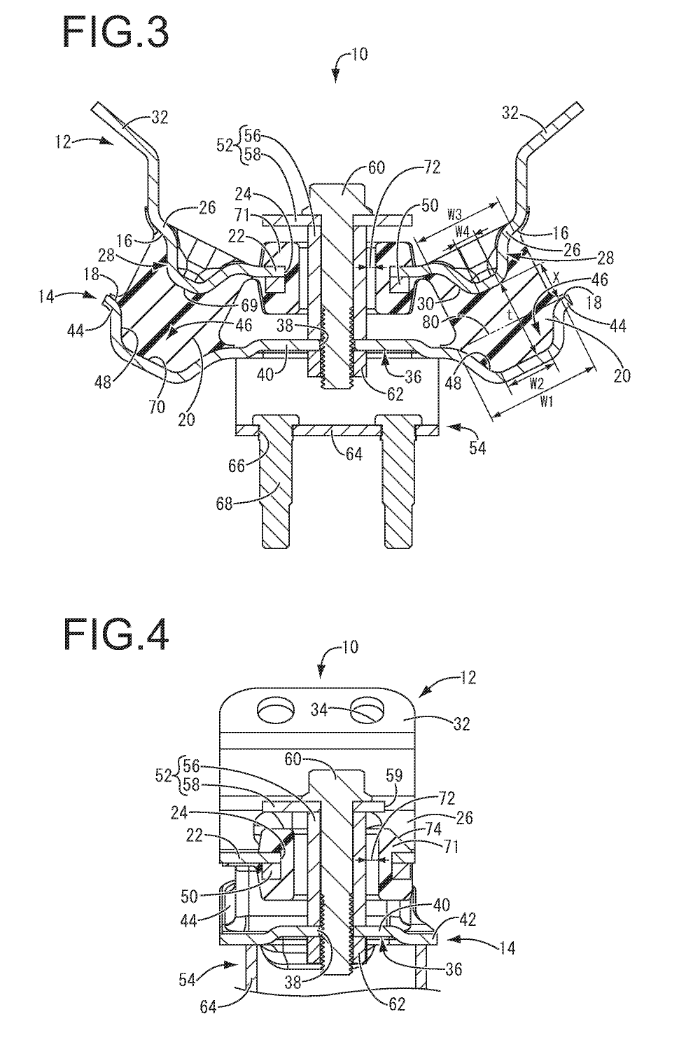

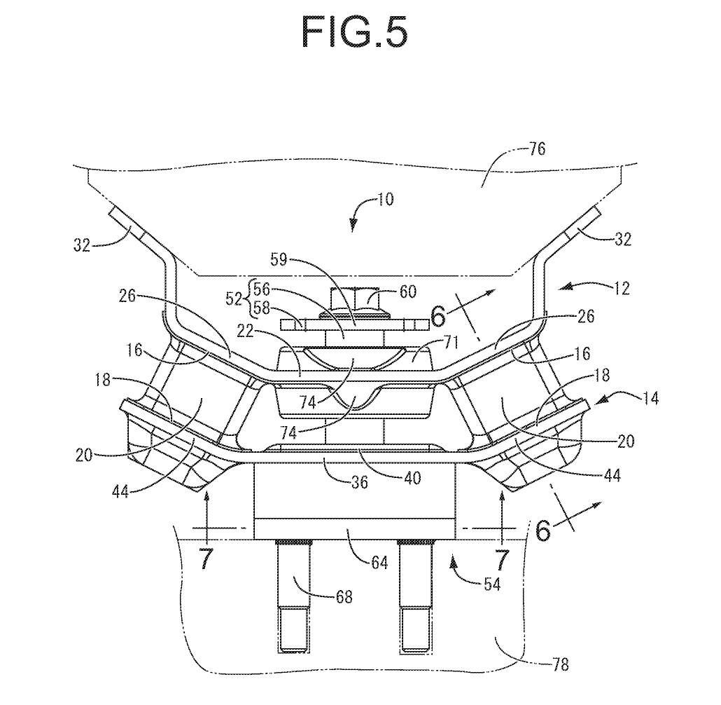

FIGS. 1 to 11 show a vibration damping device 10 serving as a first embodiment of the present invention. The vibration damping device 10 comprises a first mounting member 12 and a second mounting member 14 that have a nearly elongated plate shape, while having a structure wherein the first mounting member 12 is disposed above the second mounting member 14 so as to be opposed to the second mounting member 14 with a gap in between. On the side of the first mounting member 12 close to the second mounting member 14, first side opposition surfaces 16 are provided. Meanwhile, on the side of the second mounting member 14 close to the first mounting member 12, second side opposition surfaces 18 are provided to be disposed in opposition to the first side opposition surfaces 16 with the gap in between. The both end portions of the first mounting member 12 and the second mounting member 14 are elastically connected by a pair of main rubber elastic bodies 20, 20 that are disposed between the first side opposition surfaces 16 and the second side opposition surfaces 18. In the description hereafter, unless otherwise stated, the upper side means the upper side in FIGS. 1, 3, and 5, and the lower side means the lower side in FIGS. 1, 3, and 5. Additionally, the front side means the lower side in FIG. 2 while the back side means the upper side in FIG. 2, and the plate width direction means the up-down direction in FIG. 2, and the longitudinal direction means the left-right direction in FIGS. 3 and 5.

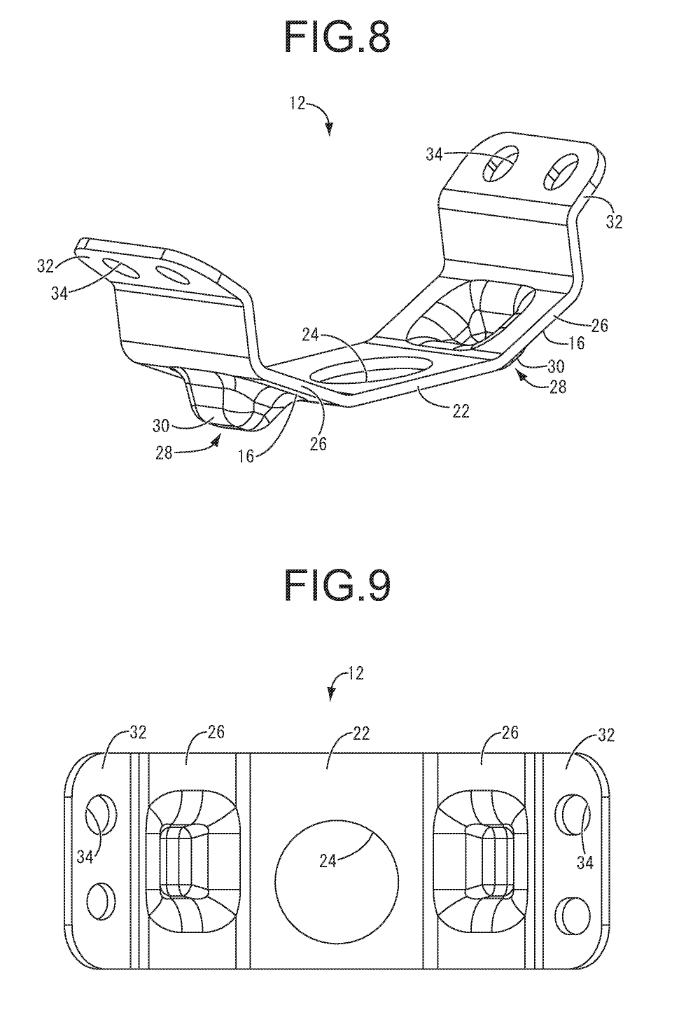

The first mounting member 12 has a roughly elongated flat plate shape as a whole. For example, the first mounting member 12 is formed with a plate material of metal such as iron and aluminum alloy using a known processing technique like press working or drawing, or with a synthetic resin material using a known molding technique like injection molding. Also, as FIGS. 8 and 9 show, the middle portion in the longitudinal direction of the first mounting member 12 is a contact plate part 22 expanding substantially horizontally and taking the generally rectangular form in a plan view (see FIG. 9). At the substantially central portion of this contact plate part 22, an insertion hole 24 is provided piercing it in the up-down direction, with a nearly circular cross-sectional shape. As FIG. 9 shows, the insertion hole 24 is formed slightly closer to the front side (the lower side in FIG. 9) than the center of the contact plate part 22.

With the opposite sides in the longitudinal direction of the contact plate part 22, a pair of first inclination plate parts 26, 26 are integrally formed. More specifically, each first inclination plate part 26 has a roughly flat plate shape extending out from each side of the longitudinal direction of the contact plate part 22 to the corresponding outside in the longitudinal direction obliquely to the upper side. The pair of left and right first inclination plate parts 26, 26 constitute the both end portions in the longitudinal direction of the first mounting member 12. In short, the pair of first inclination plate parts 26, 26 are provided at the both end portions in the longitudinal direction of the first mounting member 12 so that they are each inclined relative to the contact plate part 22 formed at the middle portion in the longitudinal direction with respect to the plate thickness direction of the contact plate part 22. Here, the lower faces of the pair of first inclination plate parts 26, 26 constitute the pair of first side opposition surfaces 16, 16, which are opposed to a pair of second inclination plate parts 44, 44 described later.

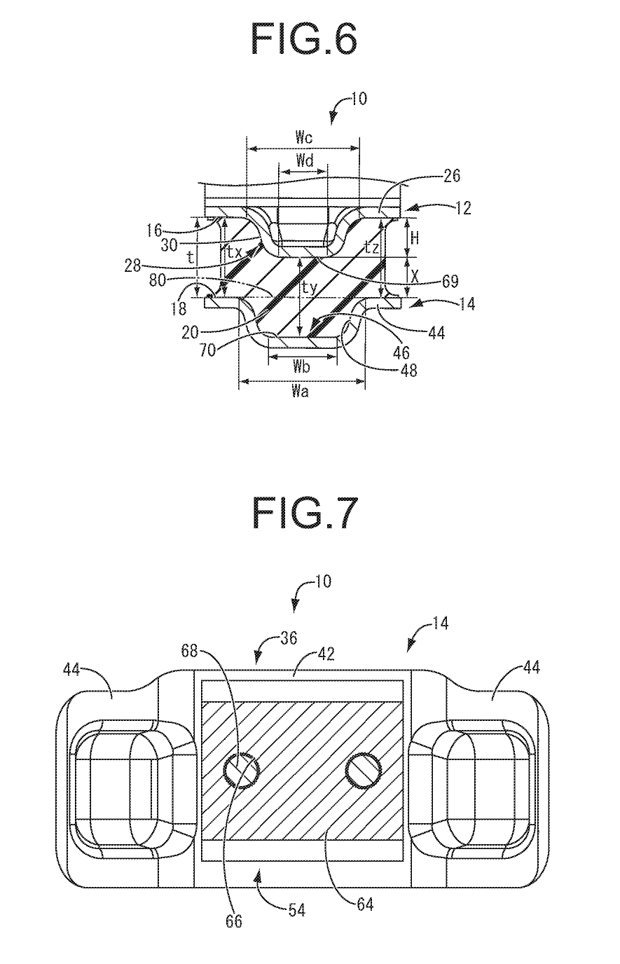

At the substantially central portion of each first side opposition surface 16 in the pair of left and right first inclination plate parts 26, 26, a protruding part 28 is formed in a generally truncated quadrangular pyramid shape that is convex obliquely outward and downward. More specifically, as FIG. 6 shows for example, the roughly central portion of each first inclination plate part 26 is pushed out toward the second side opposition surface 18 of the corresponding second inclination plate part 44 described later, with the protrusion dimension H with which the roughly central portion does not reach the second side opposition surface 18. Thus, the protruding part 28 is formed at the first side opposition surface 16 of the first inclination plate part 26. Besides, as FIGS. 3, 6, 8, and 9 show, for example, the protruding part 28 has an outer face 30 constituted by a smooth, curved face without a break or an edge, across the whole face, and it is buried in the main rubber elastic body 20, as will be described later (see FIGS. 3 and 6). This protruding part 28 can be formed by drawing, for example.

Moreover, at the outsides in the longitudinal direction of the pair of first inclination plate parts 26, 26, mounting pieces 32 are formed integrally with the first inclination plate parts 26, 26. More specifically, the mounting pieces 32 extend out from the upper ends of the pair of first inclination plate parts 26, 26 to the outsides, as slanting in a substantially doglegged shape in the front views, as FIGS. 3 and 5 show, for example. In the extending edge of each mounting piece 32, two bolt insertion holes 34 of about circular cross-sectional shape are formed through in the thickness direction, at mutually separate positions in the front-back direction (the up-down direction in FIG. 9).

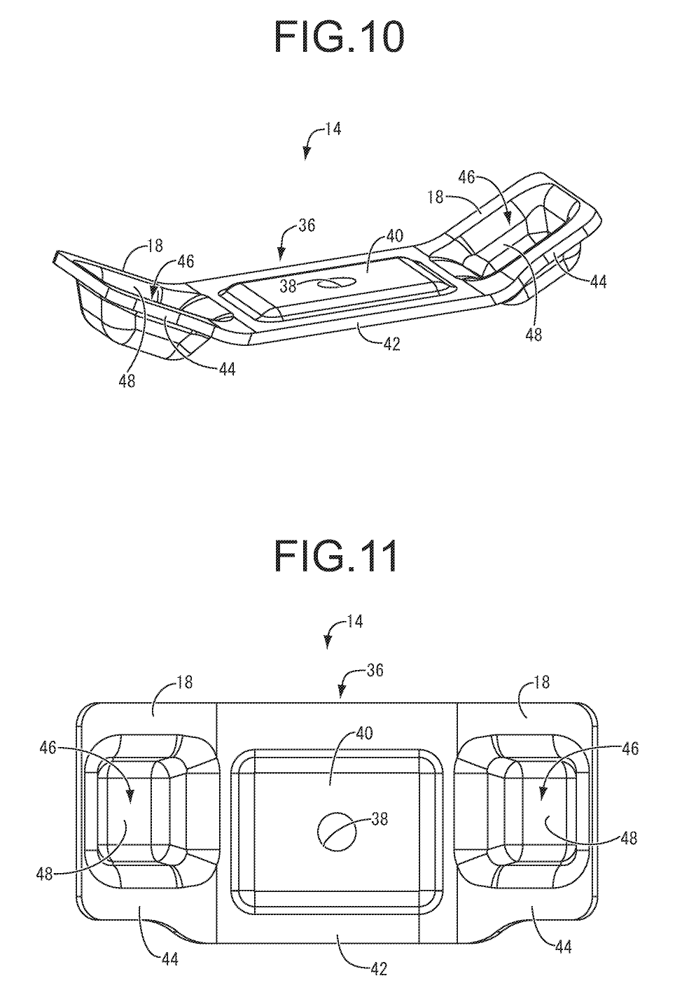

The whole second mounting member 14 has a generally elongated flat plate shape, as well as the first mounting member 12. For example, the second mounting member 14 is formed using a metal plate material of iron, aluminum alloy, or the like, or a synthetic resin material, by a known processing or molding technique. As FIGS. 10 and 11 show, the middle portion in the longitudinal direction of the second mounting member 14 is a support plate part 36 of about rectangular shape in a plan view, which expands nearly horizontally (see FIG. 11). At the substantially central portion of the support plate part 36, a bolt insertion hole 38 is provided through it in the up-down direction, with a nearly circular cross-sectional shape. As FIG. 11 shows, the bolt insertion hole 38 is formed slightly closer to the front side (the lower side in FIG. 11) than the center of the support plate part 36. Also, an embossed part 40 of about rectangular shape in a plan view is provided in the upper face of the support plate part 36 in a convex shape, thereby reinforcing the support plate part 36. At the front end of the support plate part 36, across the entirety thereof, a projection part 42 of about rectangular flat plate shape is provided projecting to the front side (the lower side in FIG. 11). This prevents an improper assembly when assembling the vibration damping device 10.

With the opposite sides in the longitudinal direction of the support plate part 36, a pair of second inclination plate parts 44, 44 are integrally formed. More specifically, each second inclination plate part 44 has a roughly flat plate shape extending out from each side in the longitudinal direction of the support plate part 36 to the corresponding outside in the longitudinal direction obliquely to the upper side. The pair of left and right second inclination plate parts 44, 44 constitute the both end portions in the longitudinal direction of the second mounting member 14. In short, the pair of second inclination plate parts 44, 44 are provided at the both end portions in the longitudinal direction of the second mounting member 14 so that they are each inclined relative to the support plate part 36 formed at the middle portion in the longitudinal direction to the same side of the plate thickness direction as the first inclination plate parts 26. Here, the upper faces of the pair of second inclination plate parts 44, 44 constitute the pair of second side opposition surfaces 18, 18, which are opposed to the pair of first inclination plate parts 26, 26.

In each second side opposition surface 18 of the pair of left and right second inclination plate parts 44, 44, a recessed part 46 is formed at about the central portion thereof, with a generally rectangular cross-sectional shape. Specifically, the recessed part 46 is formed by the roughly central portion of the second side opposition surface 18 being pushed out, to the distant side from the corresponding first inclination plate part 26 in opposition thereto. That is, the recessed part 46 is provided at the second side opposition surface 18, opening in the second side opposition surface 18 of the second inclination plate part 44. The recessed part 46 is opposed to the protruding part 28 provided at the first side opposition surface 16 of the first inclination plate part 26, and recessed to the distant side from the protruding part 28. As shown in FIGS. 3, 6, 10, and 11, for example, the recessed part 46 has an inner face 48 that is smooth and does not include a break nor an edge, across its entire face, and the recessed part 46 is filled with the main rubber elastic body 20, as will be described later (see FIGS. 3 and 6). Here, the inner face 48 includes the connection section to the second side opposition surface 18 of the second inclination plate part 44. The recessed part 46 can be formed using drawing etc., for example.

As FIGS. 1 and 3 show, for example, the first mounting member 12 and the second mounting member 14 structured in this way are disposed such that the first mounting member 12 is arranged above and opposed to the second mounting member 14. Consequently, the contact plate part 22 and the support plate part 36 are opposed in the up-down direction, while the first inclination plate parts 26 and the second inclination plate parts 44 are mutually opposed, as inclined relative to the up-down direction. A reinforcing ring 50 of about ring shape formed using a metal plate material or a synthetic resin material is fixed to the proximity of the lower opening of the insertion hole 24 of the first mounting member 12, in advance by a known means like welding. In this state, a stopper member 52 is attached to the support plate part 36 of the second mounting member 14. Subsequently, a fixation member 54 is attached to the lower face of the support plate part 36 of the second mounting member 14, using a known means like welding. The main rubber elastic body 20 is disposed for each area between the pair of first side opposition surfaces 16, 16 and the pair of second side opposition surfaces 18, 18, which are the opposed faces of the pair of first inclination plate parts 26, 26 and the pair of second inclination plate parts 44, 44, by a known means like vulcanization molding. Consequently, the pairs of opposed faces are elastically connected to one another by the pair of main rubber elastic bodies 20, 20.

As FIG. 3 shows for example, the stopper member 52 comprises a tubular axis-perpendicular stopper member 56, which is disposed on the upper side of the opening peripheral edge of the bolt insertion hole 38 in the support plate part 36 of the second mounting member 14, and an upper stopper member 58 of about circular disk shape, which is superposed on the upper face of the axis-perpendicular stopper member 56, while expanding in the horizontal direction. As FIGS. 1 and 2 show for example, a notched portion 59 is provided by cutting out a portion of the front end of this upper stopper member 58 (on the front side) by a chord extending in the longitudinal direction. A fixation bolt 60 is inserted from above through the central holes of the axis-perpendicular stopper member 56 and the upper stopper member 58, and the bolt insertion hole 38 of the second mounting member 14. Then, the inserted fixation bolt 60 is threadably mated with a nut 62 disposed on the lower side of the bolt insertion hole 38. In this way, the stopper member 52 is fixed to the support plate part 36 of the second mounting member 14.

Next, the fixation member 54 is attached to the lower face of the support plate part 36 of the second mounting member 14. More specifically, the fixation member 54 includes a fixation part 64 extending in the longitudinal direction in a gutter shape and opening to the sides of the longitudinal direction and the upper side, which has through holes 66 provided through two locations of its bottom wall mutually spaced away in the longitudinal direction, and press-fit pins 68 press-fitted through the through holes 66. This fixation member 54 is formed using a metal plate material of iron, aluminum alloy, or the like, or a synthetic resin material, by a known processing or molding technique, for example. The fixation member 54 with the press-fit pins 68 press-fitted through the through holes 66 of the fixation part 64 is attached to the lower face of the support plate part 36 of the second mounting member 14, by a known adhesion technique such as welding.

Finally, using a not-shown mold for molding, vulcanization molding is performed, with a prescribed rubber material injected into the cavity via an injection hole of the mold for molding. By so doing, the main rubber elastic bodies 20 and a rubber stopper part 71 are formed (see FIG. 3).

For example, as FIGS. 3 and 6 show, between the first side opposition surface 16 of the first inclination plate part 26 and the second side opposition surface 18 of the second inclination plate part 44, the main rubber elastic body 20 is disposed leaving no space, covering about the entirety of the opposed faces. That is, the outer face 30 of the protruding part 28 is covered by the main rubber elastic body 20 across the entire face, and buried in the main rubber elastic body 20. Here, the outer face 30 includes the connection section to the first side opposition surface 16 of the first inclination plate part 26. Thus, in the first side opposition surface 16 of the first inclination plate part 26, the protruding part 28 is provided in the section located peripherally inside the outer peripheral edge of the main rubber elastic body 20 (the section shown by W3 in FIG. 3 and Wc in FIG. 6). For the inner face 48 of the recessed part 46, the main rubber elastic body 20 is filled across the entire face.

As FIGS. 3 and 6 show for example, the minimum value of the thickness dimension t of the main rubber elastic body 20 in the opposition direction for the first side opposition surface 16 of the first inclination plate part 26 and the second side opposition surface 18 of the second inclination plate part 44 is set in relation to the maximum value. Specifically, the minimum value of the thickness dimension t is preferably 70% or larger, more preferably 80% or larger, and even more preferably 90% or larger of the maximum value of the thickness dimension t. In the present embodiment, the thickness dimension t of the main rubber elastic body 20 is substantially constant. That is, the thickness dimensions tx and tz in the opposition direction between the first side opposition surface 16 and the second side opposition surface 18 at the peripheral edge of the main rubber elastic body 20 are made substantially equal to the thickness ty in the opposition direction between a protruding tip face 69 of the protruding part 28 and a bottom face 70 of the recessed part 46 at the central part of the main rubber elastic body 20 (see FIG. 6). Thus, by forming the protruding part 28, it is possible to favorably prevent the durability deterioration due to local thinning of the main rubber elastic body 20 between the first and second side opposition surfaces 16, 18. Therefore, the durability of the vibration damping device can improve stably.

Besides, as viewed in the opposition direction for the first side opposition surface 16 of the first inclination plate part 26 and the second side opposition surface 18 of the second inclination plate part 44, the peripheral rim of the proximal end part of the protruding part 28 is positioned peripherally inside the opening peripheral edge of the recessed part 46 (W3<W1 in FIG. 3, and Wc<Wa in FIG. 6). Then, in a cross section orthogonal to the opposition direction, the width dimensions W3 and Wc of the proximal end part of the protruding part 28 are respectively set preferably 50% or larger, and more preferably 70% or larger of the width dimensions W1 and Wa of the outer peripheral edge of the recessed part 46. In this embodiment, the width dimensions W3 and Wc of the proximal end part of the protruding part 28 is respectively made equal to or larger than 80% of the width dimensions W1 and Wa of the outer peripheral edge of the recessed part 46. Consequently, in the opposition direction, any part of the main rubber elastic body 20 is prevented from being clamped directly between the proximal end part of the protruding part 28 and the second side opposition surface 18. This advantageously prevents the durability deterioration due to the protruding part 28. Moreover, the width dimensions W3 and Wc of the proximal end part of the protruding part 28 are respectively set equal to or larger than 50% of the width dimensions W1 and Wa of the outer peripheral edge of the recessed part 46. This makes it possible to exert the load (stress) expanding at a prescribed dispersion angle from the proximal end part of the protruding part 28 on a wide range of a superficial plane 80 of the second side opposition surface 18, which will be described later, with a substantially uniform distribution. Therefore, it is possible to ensure the spring characteristics of the vibration damping device set by the separation distance between the protruding part 28 and the second side opposition surface 18 in the opposition direction.

As FIGS. 3 and 6 show, in the present embodiment, for the protruding part 28, the longitudinal dimension W4 and the width dimension Wd of the protruding tip face 69 are respectively made narrower than the longitudinal dimension W3 and the width dimension Wc of the proximal end part. Specifically, the width of the outer face 30 of the protruding part 28 grows gradually narrower as it goes to the protrusion direction. In the same way, in the recessed part 46, the longitudinal dimension W2 and the width dimension Wb of the bottom face 70 are respectively made narrower than the longitudinal dimension W1 and the width dimension Wa of the upper opening. Specifically, the width of the inner face 48 of the recessed part 46 grows gradually narrower as it goes to the recession direction. Furthermore, in this embodiment, the dimensions are made such that W3≥W2 (Wc≥Wb).

Additionally, the rubber stopper part 71 is formed integrally with the main rubber elastic body 20, whereby the stopper member 52 is constituted. This rubber stopper part 71 covers the opening peripheral edge of the insertion hole 24 of the first mounting member 12 from above and below, and inside. Meanwhile, the rubber stopper part 71 is disposed as separated from the axis-perpendicular stopper member 56 of the stopper member 52 with a space 72 in the longitudinal direction. Thus, when the first mounting member 12 undergoes excessive displacement in the up-down direction relative to the second mounting member 14 due to a step of the road face etc., the rubber stopper part 71 provided in the contact plate part 22 of the first mounting member 12 gets into contact with the upper stopper member 58. This makes it possible to prevent the excessive displacement of the first mounting member 12 in the up-down direction relative to the second mounting member 14, and reduce the impact and the resultant noise in relation to direct contact between the first mounting member 12 and the upper stopper member 58. Also, when the first mounting member 12 undergoes excessive displacement in the longitudinal direction relative to the second mounting member 14 due to sudden braking, an impact, or the like, the rubber stopper part 71 provided in the contact plate part 22 of the first mounting member 12 gets into contact with the axis-perpendicular stopper member 56. This makes it possible to prevent the excessive displacement of the first mounting member 12 in the longitudinal direction relative to the second mounting member 14, and reduce the impact and the resultant noise in relation to direct contact between the first mounting member 12 and the axis-perpendicular stopper member 56. Consequently, in the vibration damping device 10 of this embodiment, the stopper function for avoiding the excessive displacement thereof is smoothly performed. Additionally, excessive elastic deformation of the main rubber elastic body 20 is prevented, whereby the durability of the main rubber elastic body 20 improves. The rubber stopper part 71 has a substantially annular shape as a whole, and, as FIGS. 1 and 5 show for example, a notch part 74 formed by obliquely cutting out a part of the outer peripheral edge of the rubber stopper part 71 is provided for the front end (on the front side), at each of two locations on the upper and lower sides of the contact plate part 22 of the first mounting member 12.

As FIG. 5 shows, in the vibration damping device 10 having this structure, the mounting pieces 32 of the first mounting member 12 are mounted on a transmission housing 76 of the power unit, which is one of the components to be linked in a vibration-damping manner, by not-shown bolts inserted through the bolt insertion holes 34. Meanwhile, the second mounting member 14 is attached to a vehicle body 78, which is the other of the components to be linked in the vibration-damping manner, by press-fitting the press-fit pins 68 attached to the fixation member 54 into not-shown press-fit holes provided in the vehicle body 78. As a result, the vibration damping device 10 is mounted between the transmission housing 76 of the power unit and the vehicle body 78, so that the power unit is supported with respect to the vehicle body 78 in a vibration-damping manner. For easier understanding, in FIG. 5, the transmission housing 76 and the vehicle body 78 are shown with imaginary lines.

According to the vibration damping device 10 of this embodiment constructed in this way, the both end portions of the first mounting member 12 and the second mounting member 14 are elastically connected by the pair of main rubber elastic bodies 20, 20 disposed between the first side opposition surfaces 16 and the second side opposition surfaces 18. At about the central portion of each first side opposition surface 16, the protruding part 28 is provided. The protruding part 28 protrudes toward the second side opposition surface 18 of the second inclination plate part 44 while being buried in the main rubber elastic body 20, in the section located peripherally inside the outer peripheral edge of the main rubber elastic body 20 (the section shown by W3 in FIG. 3 and Wc in FIG. 6). On the other hand, at each second side opposition surface 18, the recessed part 46 is opposed to the protruding part 28 provided at the first side opposition surface 16 of the first inclination plate part 26 and recessed to the distant side from the protruding part 28. The recessed part 46 opens in the second side opposition surface 18 of the first inclination plate part 26 and is filled with the main rubber elastic body 20. Thus, an input load between the first side opposition surface 16 and the second side opposition surface 18 exerts the distribution load (stress) expanding from the protruding part 28 toward the second side opposition surface 18 with a prescribed dispersion angle on the superficial plane 80 of the second side opposition surface 18 including the cover plane of the recessed part 46 filled with the main rubber elastic body 20 (see FIGS. 3 and 6). Therefore, it is possible to freely set the spring characteristics of the vibration damping device 10 of the present embodiment, by adjusting the separation distance X between the protruding part 28 and the superficial plane 80 of the second side opposition surface 18 in the opposition direction for the first side opposition surface 16 and the second side opposition surface 18 (see FIGS. 3 and 6). For easier understanding, in FIGS. 3 and 6, the superficial plane 80 is shown with an imaginary line. The protruding part 28 buried in the main rubber elastic body 20 is provided in the section located peripherally inside the outer peripheral edge of the main rubber elastic body 20. As a result, the distance t between the opposed faces, namely the first side opposition surface 16 and the second side opposition surface 18, is made large. This makes it possible to largely keep the free length of the surface of the main rubber elastic body 20, and thus to surely improve the durability of the main rubber elastic body 20, and hence that of the vibration damping device 10.

The protruding part 28 buried in the main rubber elastic body 20 includes the outer face 30 constituted by a smooth curved face without a break or an edge. This enables increase of the bonded area of the main rubber elastic body 20 on the protruding part 28, thereby enabling further improvement in the durability of the main rubber elastic body 20. Additionally, the inner face 48 of the recessed part 46 filled with the main rubber elastic body 20 is also constituted by a smooth curved face without a break or an edge, across its entire face. This prevents local stress concentration on the main rubber elastic body 20 due to the recessed part 46 as well as the protruding part 28, whereby the durability of the main rubber elastic body 20 can further improve. Moreover, the recessed part 46 is provided to be opposed to the protruding part 28 and recessed to the distant side from the protruding part 28. Consequently, the separation distance between the protruding tip face 69 of the protruding part 28 and the bottom face 70 of the recessed part 46 can be sufficiently kept, and the increase of the rubber volume allows further improvement in the durability of the main rubber elastic body 20. In this way, according to the vibration damping device 10 of this embodiment, it is possible to favorably realize both securement of the required spring characteristics and the improvement of the durability.

In the vibration damping device 10 of the present embodiment, the main rubber elastic body 20 is disposed for each area between the pair of first side opposition surfaces 16, 16 and the pair of second side opposition surfaces 18, 18, which are the opposed faces of the pair of first inclination plate parts 26, 26 and the pair of second inclination plate parts 44, 44. Consequently, the pairs of opposed faces are elastically connected to one another by the pair of main rubber elastic bodies 20, 20. This configuration allows adjustment of the ratio between the spring in the length direction and the spring in the opposition direction for the first mounting member 12 and the second mounting member 14, by adjusting the inclination angle for the first inclination plate parts 26 and the second inclination plate parts 44. By providing the protruding parts 28 and the recessed parts 46, the central portion of each second inclination plate part 44 is largely pushed out to the outside. However, the recessed parts 46 protruding outward are smartly accommodated in the void spaces made by the aforesaid inclination angle, so that it is possible to improve the durability without enlargement of the disposition space.

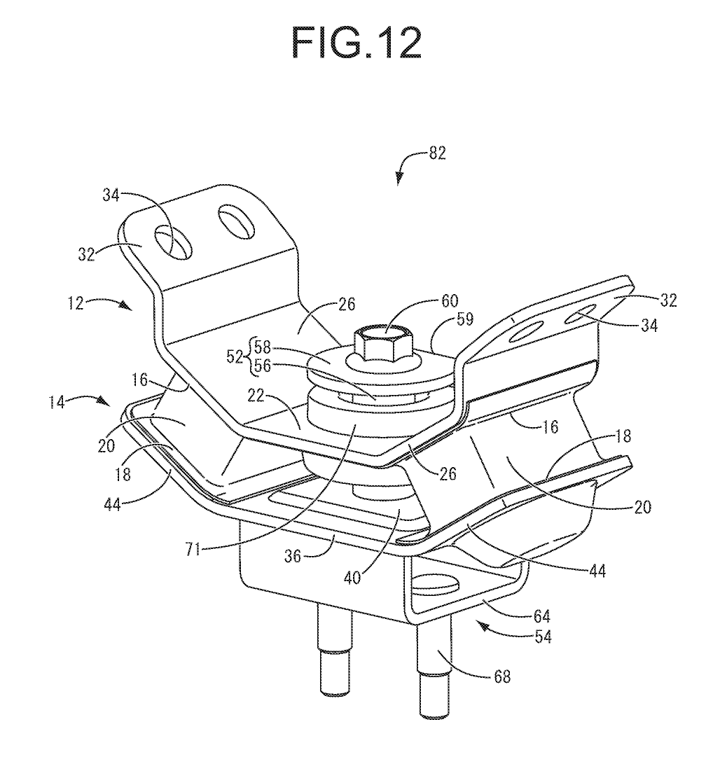

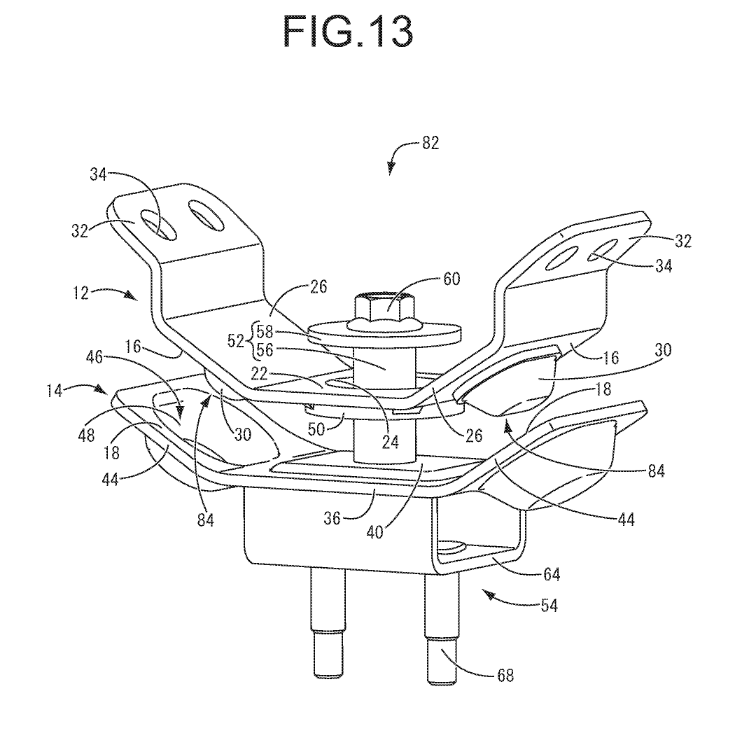

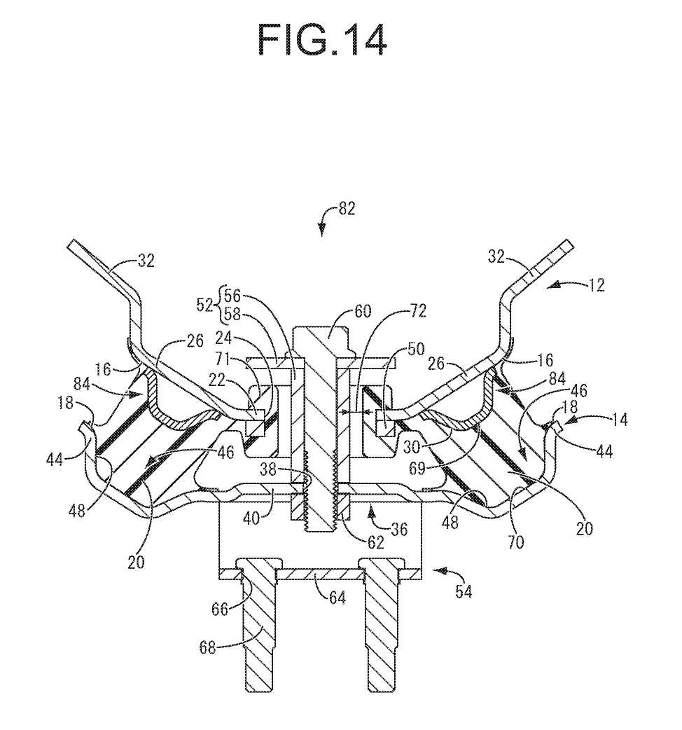

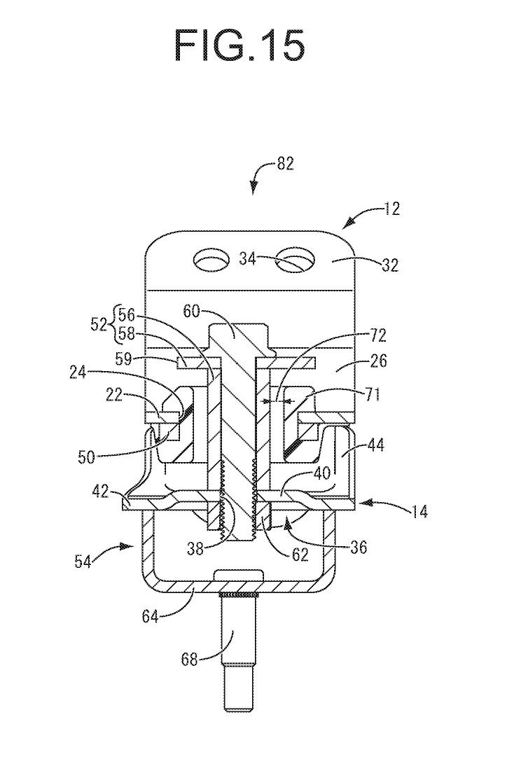

The embodiments of this invention have been described above, but the present invention is not limited by the specific descriptions of the embodiments. For example, in the aforementioned embodiment, the protruding part 28 is formed by using a known means like drawing on the first inclination plate part 26 of the first mounting member 12, integrally with the first inclination plate part 26. However, it is also possible to form separately the protruding part and fix it to the first inclination plate part 26 by a known means such as welding, like a protruding part 84 of a vibration damping device 82 serving as a second embodiment shown in FIGS. 12 to 15. This makes it easier to form the protruding part 84, thus enabling cost reduction.

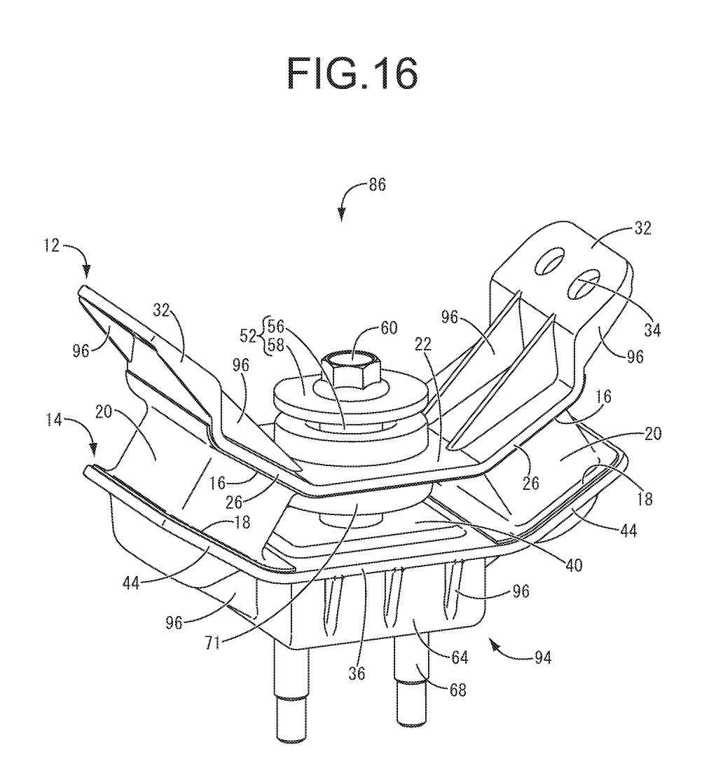

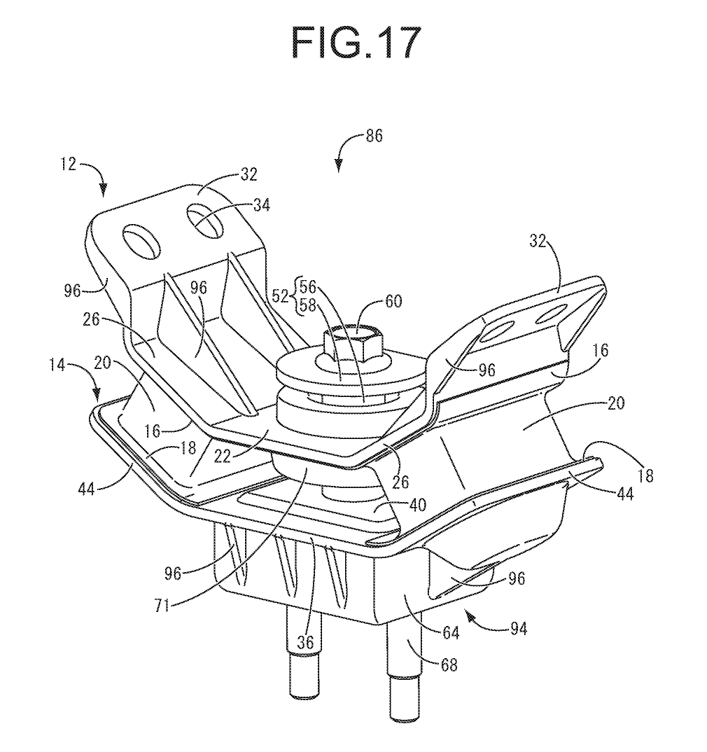

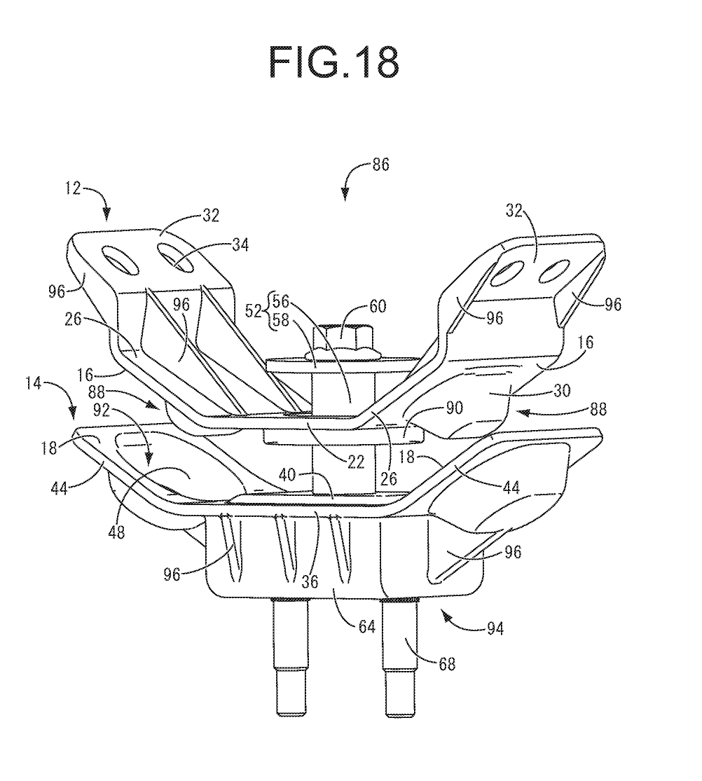

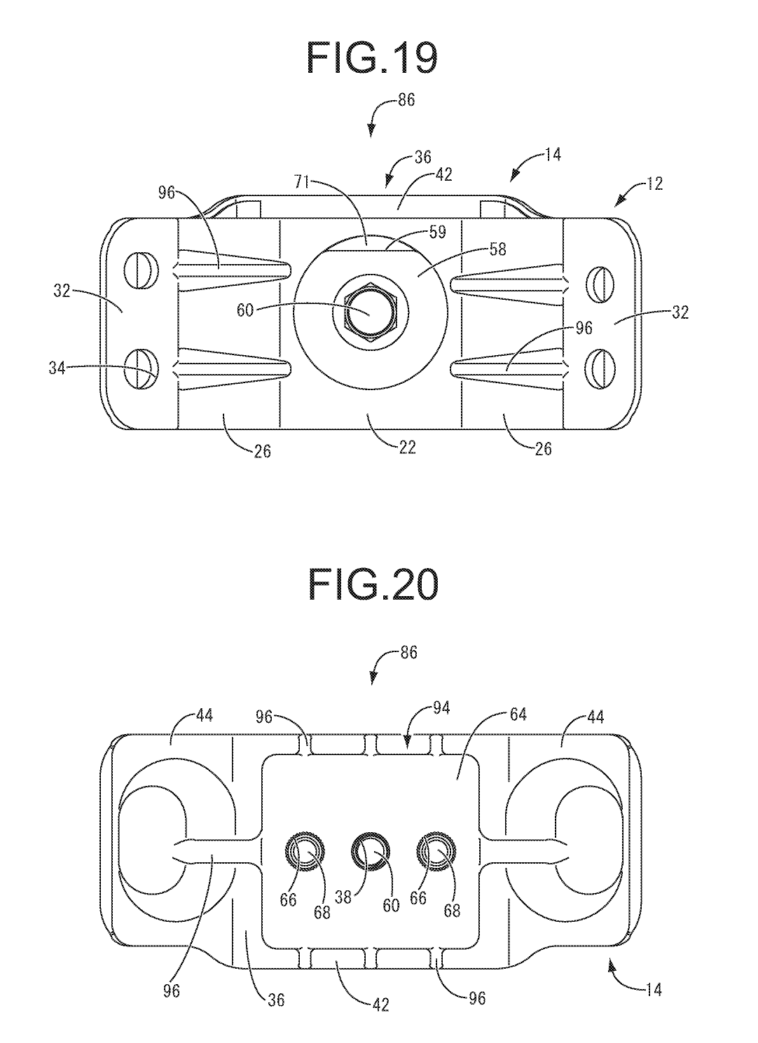

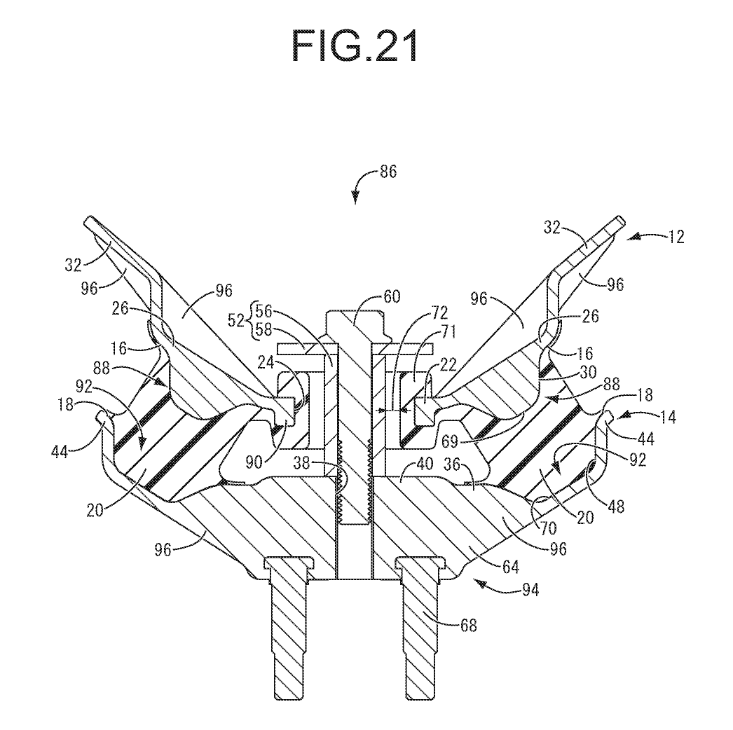

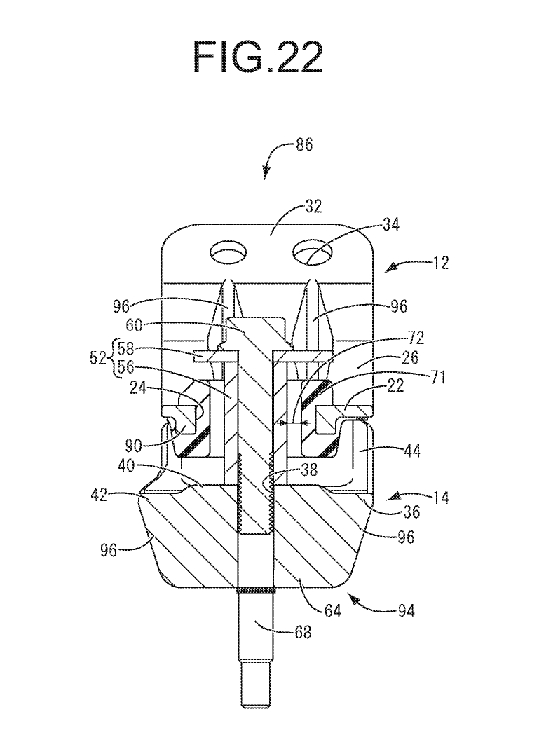

In the first embodiment, the protruding part 28 is formed by using a known means like drawing on the first inclination plate part 26 of the first mounting member 12. Alternatively, it is possible to integrally form the protruding part using a known technique such as die casting of aluminum and injection molding of synthetic resin, like a protruding part 88 of a vibration damping device 86 serving as a third embodiment shown in FIGS. 16 to 22. In this embodiment, it is possible to form a reinforcing ring 90 integrally with the first mounting member 12, meanwhile, in relation to the second mounting member 14, it is possible to form not only a recessed part 92 but also a fixation member 94 integrally with the second inclination plate part 44. This makes it easier to form the protruding part 88 and the reinforcing ring 90 for the first mounting member 12, and to form the recessed part 92 and the fixation member 94 for the second mounting member 14, thus allowing cost reduction. Besides, reinforcing ribs 96 of about triangular flat plate shape in a rear view or a side view are provided at the first mounting member 12 and the second mounting member 14, for reinforcing the vibration damping device 86.

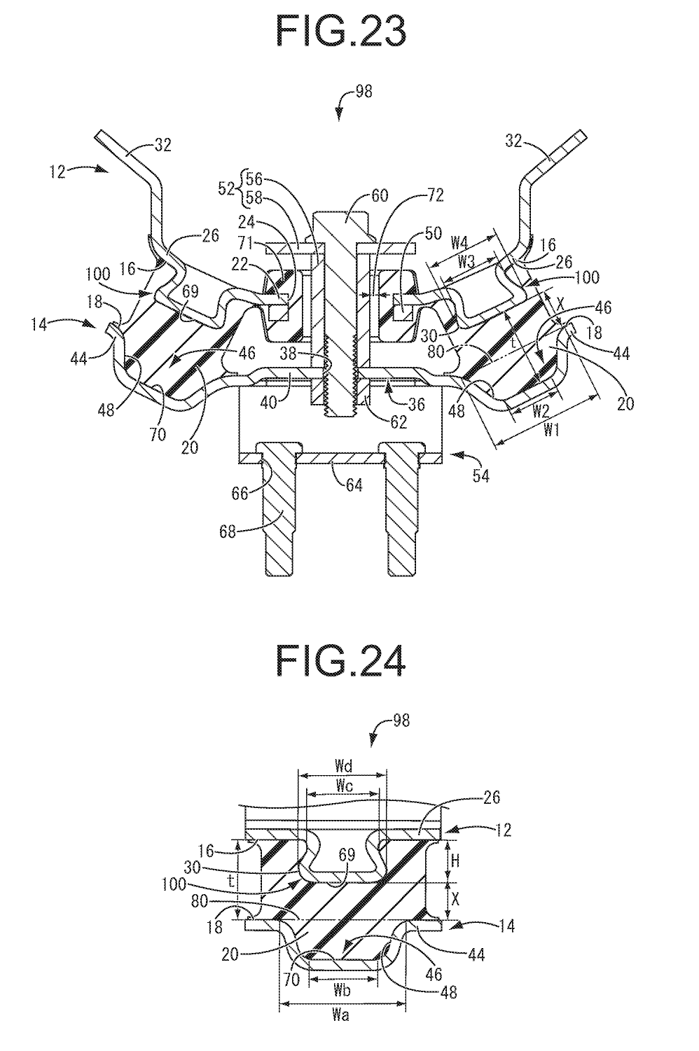

In the first embodiment, the protruding part 28 has a roughly truncated quadrangular pyramid shape that is convex obliquely downward and outward. For example, as FIGS. 3 and 6 show, the longitudinal dimension W4 and the width dimension Wd of the protruding tip face 69 are respectively made narrower than the longitudinal dimension W3 and the width dimension Wc of the outer face 30 of the proximal end part. In summary, the width of the outer face 30 of the protruding part 28 grows gradually narrower as it goes to the protrusion direction. On the other hand, the protruding part may have a substantially inverted, truncated quadrangular pyramid shape that is convex obliquely downward and outward, like a protruding part 100 of a vibration damping device 98 serving as a fourth embodiment shown in FIGS. 23 and 24. Specifically, the longitudinal dimension W4 and the width dimension Wd of the protruding tip face 69 may be respectively made wider than the longitudinal dimension W3 and the width dimension Wc of the outer face 30 of the proximal end part so that the width of the protruding part 28 grows gradually wider as it goes to the protrusion direction. Thus, an input load between the first side opposition surface 16 and the second side opposition surface 18 exerts the distribution load (stress) expanding from the protruding tip part of the protruding part 28 toward the second side opposition surface 18 with a prescribed dispersion angle on a wider range. Therefore, it is possible to further stable the desired spring characteristics.

For the first to third embodiments, the first side opposition surface 16 and the second side opposition surface 18 are disposed in opposition to each other as parallel, but they may be disposed in opposition as inclined relative to each other. Moreover, for the first to third embodiments, the first side opposition surfaces 16, the second side opposition surfaces 18, and the main rubber elastic bodies 20 connecting them are provided at two locations. However, this invention will do as long as they are provided at at least one location in the vibration damping devices 10, 82, 86, 98, and they may be provided at three or more locations. Furthermore, the first inclination plate parts 26 and the second inclination plate parts 44, which are opposed, are not limited to the inclination plate parts bent upward like examples. In other words, the first inclination plate parts 26 and the second inclination plate parts 44 may be bent downward, and this invention can also employ the inclination plate parts directed to any advantageous direction depending on the disposition space.

### EXPLANATION OF NUMERALS

10, 82, 86, 98: vibration damping device; 12: first mounting member; 14: second mounting member; 16: first side opposition surface; 18: second side opposition surface; 20: main rubber elastic body; 26: first inclination plate part; 28, 84, 88, 100: protruding part; 30: outer face; 44: second inclination plate part; 46, 92: recessed part; 48: inner face 69: protruding tip face; 70: bottom face; 76: transmission housing (one of components); 78: vehicle body (other of components);

What is claimed is:

1. A vibration damping device for linking components in a vibration-damping manner comprising:
a first mounting member configured to be mounted on one of the components;
a second mounting member configured to be mounted on an other of the components;
at least one first side opposition surface provided in the first mounting member;
at least one second side opposition surface provided in the second mounting member and opposed to the first side opposition surface with a gap in between;
at least one main rubber elastic body being disposed between the first side opposition surface and the second side opposition surface to elastically connect them;
a protruding part provided at the first side opposition surface so as to protrude toward the second side opposition surface with a protrusion dimension with which the protruding part does not reach the second side opposition surface, in a section located peripherally inside an outer peripheral edge of the main rubber elastic body, the protruding part having an outer face without a break and being buried in the main rubber elastic body; and
a recessed part provided at the second side opposition surface in opposition to the protruding part while being recessed to a distant side from the protruding part and opening in the second side opposition surface, the recessed part being filled with the main rubber elastic body.

2. The vibration damping device according to claim 1, wherein, in an opposition direction for the first side opposition surface and the second side opposition surface, a minimum value of a thickness dimension of the main rubber elastic body is equal to or larger than 70% of a maximum value of the thickness dimension of the main rubber elastic body.

3. The vibration damping device according to claim 2, wherein the thickness dimension in the opposition direction between the first side opposition surface and the second side opposition surface at a peripheral edge of the main rubber elastic body is made substantially equal to the thickness dimension in the opposition direction between a protruding tip face of the protruding part and a bottom face of the recessed part at a central part of the main rubber elastic body.

4. The vibration damping device according to claim 1, wherein each of the outer face of the protruding part buried in the main rubber elastic body and an inner face of the recessed part filled with the main rubber elastic body is constituted by a curved face without an edge.

5. The vibration damping device according to claim 1, wherein, as viewed in an opposition direction for the first side opposition surface and the second side opposition surface, a peripheral rim of a proximal end part of the protruding part is positioned peripherally inside an opening peripheral edge of the recessed part, and a width dimension of the proximal end part of the protruding part in a cross section orthogonal to the opposition direction is set equal to or larger than 50% of a width dimension of the opening peripheral edge of the recessed part.

6. The vibration damping device according to claim 1, wherein
each of the first mounting member and the second mounting member has an elongated plate shape, and the first mounting member is disposed above the second mounting member so as to be opposed to the second mounting member with the gap in between,
a pair of first inclination plate parts are provided at both end portions in a longitudinal direction of the first mounting member so as to be each inclined relative to a middle portion in the longitudinal direction of the first mounting member with respect to a plate thickness direction of the middle portion,
a pair of second inclination plate parts are provided at both end portions in the longitudinal direction of the second mounting member so as to be each inclined to the same side of the plate thickness direction as the first inclination plate parts are inclined,
the at least one first side opposition surface comprises a pair of first side opposition surfaces while the at least one second side opposition surface comprises a pair of second side opposition surfaces, and opposed faces of the pair of first inclination plate parts and the pair of second inclination plate parts are the pair of first side opposition surfaces and the pair of second side opposition surfaces, and the at least one main rubber elastic body comprises a pair of main rubber elastic bodies, and the pair of main rubber elastic bodies elastically connect the pair of first side opposition surfaces and the pair of second side opposition surfaces to each other, and
a central portion of each of the second inclination plate parts is pushed out to a distant side from a corresponding one of the first inclination plate parts in opposition thereto so as to form the recessed part in each of the second side opposition surfaces.
